(19) United States
(12) Patent Application Publication
(10) Pub. No.: US 2026/0182506 A1
(43) Pub. Date: Jul. 2, 2026

(54) DEVICE FOR DISCHARGING MUSHROOMS FROM A CONVEYOR

(71) Applicant: Jacobus Alexander Jozef LEMMEN, Venlo (NL)

(72) Inventor: Jacobus Alexander Jozef LEMMEN, Venlo (NL)

(21) Appl. No.: 19/130,716

(22) PCT Filed: Nov. 24, 2023
(86) PCT No.: PCT/EP2023/083009

§ 371 Date: May 16, 2025

(30) Foreign Application Priority Data
Nov. 30, 2022 (NL) 2033640
Feb. 20, 2023 (NL) 2034181
Sep. 26, 2023 (NL) 2035881

(51) Int. Cl. A01G 18/70; B65B 25/04; B65G 47/82

(52) U.S. Cl. CPC A01G 18/70; B65G 47/82; B65B 25/04; B65G 2201/0211

(57) ABSTRACT

The invention concerns a device (1) for discharging mushrooms (2) from a conveyor (3), in particular a conveyor belt and/or an endless conveyor, for conveying the mushrooms (2) in a direction of conveyance (c); wherein the mushroom conveyor (3) has a surface (4) for carrying the mushrooms (2), which surface (4) extends between two sides that are mutually spaced in a direction perpendicular to the direction of conveyance (c); and the mushroom conveyor (3) being guided along a trajectory from a charging location such as a picking location to a discharging location, such as a filling station for mushroom containers (7); wherein the mushroom conveyor (3) has holes (8) for mushroom stipes (9), more in particular holes (8) at a regular distance from each other in the direction of conveyance; wherein the device (1) further comprises a pusher (10), arranged underneath the conveyor (3) at the discharging location, for pushing at least the mushroom stipes (9) out of the holes (8) with a pushing surface (11).

The present invention relates to a device for discharging mushrooms from a conveyor.

Mushrooms are grown in beds with compost and casing soil, that are suspended in shelvings, often in multiple layers on top of each other. The mushrooms are picked from there and transported to a packaging location by means of a harvesting belt or harvesting conveyor. From that conveyor, they need to be transferred to containers, in which they are transported and/or finally sold.

Transferring mushrooms from the harvesting belt to a container is a precious step, because the mushrooms are easily damaged, and when handled too rough, they may decolour, and become less valuable or even unsuitable for sales.

Device for discharging mushrooms from a conveyor exist, for instance as described in the European Patent Application EP 20204982 from the same applicant. However, this system has the disadvantage that discharging can only take place at a far end of a harvesting conveyor, and the construction requires further technical measures to reduce a falling height of the mushrooms, which needs to be as small as possible. For that reason, there appeared to be room for further improvement.

The international patent application PCT/EP2022/052923 by the same applicant describes further solutions and is herein incorporated by reference. However, the need for useful alternatives remains.

It is therefore a goal of the present invention to provide a device for discharging mushrooms from a conveyor that takes away the disadvantages of the prior art.

The invention thereto proposes a device for discharging mushrooms from a conveyor, comprising: a mushroom conveyor, in particular a conveyor belt and/or an endless conveyor, for conveying the mushrooms in a direction of conveyance wherein the mushroom conveyor has a surface for carrying the mushrooms, which surface extends between two sides that are mutually spaced in a direction perpendicular to the direction of conveyance; and the mushroom conveyor being guided along a trajectory from a charging location such as a picking location to a discharging location, such as a filling station for mushroom containers; wherein the mushroom conveyor has holes for mushroom stipes, more in particular holes at a regular distance from each other in the direction of conveyance as well as a pusher, arranged underneath the conveyor at the discharging location, for pushing at least the mushroom stipes out of the holes with a pushing surface.

The pushing surface may comprise or may form part of a rod or a plate, configured for direct physical contact with a mushroom, in particular with its stipe. The pusher position may be stationary with respect to the direction of conveyance. The pusher may be configured for selectively pushing individual mushrooms.

The pusher may be movable, for pushing, with a vertical directional component and a horizontal directional component, in order to push the mushroom to a side of the conveyor, seen in the direction of conveyance. The pushing surface is configured for pushing along a curved path with a directional component toward a side of the conveyor belt.

The device according to the invention may comprise a twister, located at the discharging location, for at least locally twisting a plane in which the surface of the mushroom conveyor lies, wherein the twister is configured to twist the mushroom conveyor about an axis parallel to direction of conveyance.

The axis may coincide with the centre or a side of the mushroom conveyor.

The twister may comprise a ramp for guiding the mushroom conveyor, wherein the ramp extends over a full width of the mushroom conveyor, and in particular wherein the angle wherein the ramp twists the conveyor is adjustable, and/or wherein the ramp is exchangeable, wherein the ramp has a recess or a different height at the area where it supports the part of the mushroom conveyor that comprises the holes.

In a further embodiment, the device according to the invention comprises a mushroom conveyor, in particular formed by a first conveyor belt and/or an endless conveyor, for conveying the mushrooms in a direction of conveyance wherein the mushroom conveyor has a surface for carrying the mushrooms, which surface extends between two sides that are mutually spaced in a direction perpendicular to the direction of conveyance; and the mushroom conveyor being guided along a trajectory from a charging location such as a picking location to a discharging location, such as a filling station for mushroom containers; wherein the mushroom conveyor has holes for mushroom stipes, more in particular holes at a regular distance from each other in the direction of conveyance as well as a pusher, arranged underneath the conveyor at the discharging location, for pushing at least the mushroom stipes out of the holes with a pushing surface, wherein the pusher comprises a pusher belt, which is a second belt, that is at positioned at a distance below the surface of the mushroom conveyor and which is at least locally movable toward the mushroom conveyor surface from the bottom side. The second belt may follow a path that is (essentially) shorter than the path of the mushroom conveyor and be entirely comprised within the path that the mushroom conveyor follows.

The second belt may be movable toward the first conveyor belt by means of a pushing device that can be operated to locally lift the second belt, in particular from underneath, and which can be operated for lifting a single mushroom. In order to enable the lifting, a provision, such as a tensioner, can be present elsewhere in the path.

The second belt may have a speed that is at least equal to the speed of the mushroom conveyor belt or harvesting belt, to keep the friction on the mushroom stipes at a minimum.

The mushroom conveyor belt or harvesting belt may be provided with openings that have an at least partially tapered shape, in order to clamp the stipes and support the caps. In such case, it may be beneficial to set the speed of the second belt somewhat higher, for instance between 0 and 5% of the speed, in order to assist in taking the mushrooms out of their holes during lifting. The second belt may preferably be used in combination with a ramp.

In another embodiment, the belt may be provided with openings that have a shape that is at least partially tapered perpendicular to the direction of conveyance. In order to discharge the mushrooms from the conveyor, a slider may be present, forming means to slide the mushrooms in the direction wherein tapered part of the opening widens. When the mushrooms are slided in said direction they are no longer held in a touching manner in the opening, and can be removed without being stuck in the opening or being scratched by the edge of the opening.

Such slider may be a static device such as a guidance bar, that extends both in a direction of conveyance of the conveyor belt and in a direction in which the tapered part of the openings of the belt widens, or, in other words, under an angle with respect to said direction of conveyance. The slider is positioned under the belt, that is, at the side wherein the stipes stick through the openings, or in other words the site remote from the side that supports the mushroom caps. It is positioned such that it engages stipes of mushrooms when transported by the belt.

The device may further comprise a pusher of the aforementioned type. Also in this embodiment, the belt may be twisted at the location where mushrooms are to be discharged. That may be done by means of a ramp of the aforementioned type. In that case, the twisting of the conveyor belt and/or the ramp are oriented such that the slider slides the mushrooms in the direction wherein the height of the ramp increases. This should then also be the direction in which the tapered part of the opening widens.

The slider and the pusher may be separate parts and/or devices. It is also thinkable that they are the same part. In both cases the slider and or the pusher may be static or dynamic parts. A dynamic part is to be understood as a part that is movable with respect to the surface of the conveyor belt. In a preferred embodiment, the slider is a fixed part and the pusher is a separate movable part.

The invention may comprise a combination of a device as described above and a filling station for mushroom containers, such as trays, wherein the filling station comprises means such as at least one container conveyor for providing mushroom containers, wherein the means convey the containers to the discharging location, for catching mushrooms discharged from the mushroom conveyor.

Such combination may comprise multiple means, and in particular multiple container conveyors, at a mutual distance in the transport direction, leading to different filling stations at various positions at the mushroom conveyor, wherein the pushers are controllable, such that mushrooms can be selectively removed from the mushroom conveyor at one filling station, while already having passed another filling station upstream.

Selective removal may be based on mushroom properties such as size and weight, which is measured or otherwise determined at an upstream location.

The filling station may comprise means such as at least one container conveyor for providing mushroom containers, wherein the means convey the containers to a location below the twister, for catching mushrooms discharged from the mushroom conveyor.

The means such as at least one container conveyor may extend from a destacker location where containers are destacked onto the means such as at least one container conveyor, in particular to a buffer location, where containers are stored for buffering. In order to meet food-grade requirements, the conveyor is preferably made of one piece, that is, a flexible material. More preferably it is free of interconnected parts and in particular it does not comprise hinges or links.

In order to be able to follow the ramp and more in particular to be twisted. Twisting means, unlike (simple) bending, undergoing a double curvature, that is a bend in two directions perpendicular to each other. The material should therefore preferably be flexible both in a direction of conveyance and a direction perpendicular thereto. However, it should hardly or not be stretched of stretchable at least in the direction of conveyance.

Normally, the plane on which the mushrooms are conveyed is an essentially horizontal plane. The trajectory the mushroom conveyor follows may comprise uphill or downhill parts, but normally never be so steep that the mushrooms may fall off the conveyor, or move on the conveyor. Normally, when uphill or downhill trajectories are considered necessary, a mushroom conveyor with holes for mushroom stipes, more in particular holes at a regular distance from each other in the direction of conveyance may be used.

In a preferred embodiment, the twister is configured to twist the mushroom conveyor about an axis parallel to direction of conveyance. This axis may coincide with the centre or a side of the mushroom conveyor. Twisting about the direction of conveyance has the advantage that a minimal falling distance can be obtained. The choice for the exact position of the axis about which the conveyor is twisted may depend on available space and further technical design choices.

In a practical realisation, the twister comprises a ramp for guiding the mushroom conveyor. The ramp defines the position where the twisting starts, the distance over which it takes place, that maximum angle, and whether the ramp extends over a full width of the mushroom conveyor. Such ramp may be adjustable, in particular the angle wherein the ramp twists the conveyor may be adjustable, and/or the ramp may be a physical object that is exchangeable with a ramp with different dimensions, such as a different angle or length.

In a preferred embodiment, the ramp is displaceable in and against the direction of conveyance of the belt, in order to be able to change the position wherein the mushrooms are discharged. In a further embodiment, the position is automatically movable, in use, that is when the conveyor is moving. In yet a further embodiment, the position is automatically driven forward and back to discharge mushrooms over a distance along the path of the conveyor. This allows to evenly fill containers passing the discharge location. Alternatively, multiple ramps may be present, at multiple discharge locations.

The ramp may have a different height at the area where it supports the part of the mushroom conveyor that comprises the holes, or differently stated, there may be a slot in at least part of the ramp to allow mushroom stems to pass.

In a further embodiment, the mushroom conveyor comprises multiple parallel lanes of holes, for conveying multiple lanes, such as two or three or four or five lanes of mushrooms in parallel.

Twisting of the conveyer belt may then be done such that only a part of the conveyor belt is twisted, in order to discharge only mushrooms of one or more specific lanes.

In all embodiments described, there may be a mushroom-guidance, that guides mushrooms pushed out of the holes to an intended side of the mushroom conveyor. If the conveyor belt is twisted, its lower side normally will be the intended side. The mushroom guidance may be configured for physical contact, be static such as a fixed plate (which may be curved) or dynamic such as a second pusher, or be configured not to make physical contact with the mushroom, such as a nozzle for creating an air stream that moves the mushroom.

There may be multiple discharging locations behind each other downstream the direction of conveyance. The belt may be twisted in different ways at different locations, in order to discharge mushrooms from different lanes at those locations.

Alternatively, there may be a number of discharge locations with pushers, and the pushers may be controlled based on upstream determined mushroom properties such as size and/or weight and/or quality.

There may be a bend in the mushroom conveyor at the height of a or one of the discharge stations, which bend allows only part of the mushroom conveyor in the direction perpendicular to the direction of conveyance to be bent.

The device as described above may be combined with a filling station for mushroom containers, such as trays, wherein the filling station comprises a container means such as a conveyor for providing mushroom containers, wherein the container conveyor conveys the containers to a location below the twister, for catching mushrooms discharged from the mushroom conveyor. The container conveyor may preferably pass underneath the mushroom conveyor at the smallest possible distance, in order to minimize the falling distance of the mushroom. The conveyor may provide various and/or mutually different containers.

Embodiments are also thinkable, comprising multiple means, and in particular multiple container conveyors, at a mutual distance in the transport direction. These different conveyors then lead to different filling stations at various positions at the mushroom conveyor.

The twisters and/or the pushers may in particular in those cases be controllable, such that mushrooms can be selectively removed from the mushroom conveyor at one filling station, while already having passed another filling station upstream. Such selection may be done based on mushroom properties such as size and weight, which may be measured or otherwise determined at an upstream location.

The container conveyor may preferably be configured for conveying the containers such that a bottom plane of the conveyors is under an angle with the horizontal plane. By having the containers tilted at the moment of filling, and more in particular by moving them simultaneously, the mushrooms are deposited adjacently to each other in the containers, which reduces the falling distance even further.

For that purpose, in a preferred embodiment, the container conveyor is configured for moving the container with at least a directional component, or in a direction perpendicular to the direction of conveyance while catching mushrooms discharged from the mushroom conveyor. However, a movement of containers parallel to the mushroom conveyor is also thinkable.

The container conveyor may for instance extend from a destacker location where containers are destacked from a stack, onto the container conveyor, to a buffer location, where containers are stored for buffering. In such configuration, the device for discharging the mushrooms may be configured to discharge an amount or weight or volume of mushrooms to the container, that is less than a desired amount to fill the container with. The last part of the filling can then be done manually, or by means of a robot or similar device that is configured for placing the mushrooms in a specific orientation as a top layer in the container.

Such configuration may comprise a second or further mushroom conveyor, extending from a second picking location to the buffer location. The mushrooms from the second conveyor may then be used to top-up the containers filled with second mushroom conveyor may be used to top up the containers filled with mushrooms from the first mushroom conveyor. Here, specific care may be taken that the mushrooms in the top layer are oriented in a neat and presentable way, which is normally with their caps up and stipes down. The buffer location may also comprise a check weigher, to make sure the containers are filled with the correct weight.

The invention also relates to a method for harvesting and packaging mushrooms, comprising one or more of the steps of:
Growing the mushrooms in cells;
Harvesting the mushrooms either manually or with the aid of tooling such as a robot or a combination thereof;
Transporting the harvested mushrooms, in particular out of the cells with a harvesting conveyor;
Transferring the harvested mushrooms from the harvesting conveyor to a container, in particular at least partly in the way described above; and more in particular at least partly, such as up to 75% automatically and partly manually;
Cooling the mushrooms and the containers, and transport them for further handling, wherein further handling in particular comprises further packaging such as covering the package.

The invention also relates to a conveyor for mushrooms and/or mushroom packages, wherein an area closely (that is: less than 50 cm around and in particular about 15 cm around the conveyor) surrounding the conveyor is shielded and the area between the shielding and the conveyor is cooled.

The invention will now be elucidated into more detail with reference to the following figures.

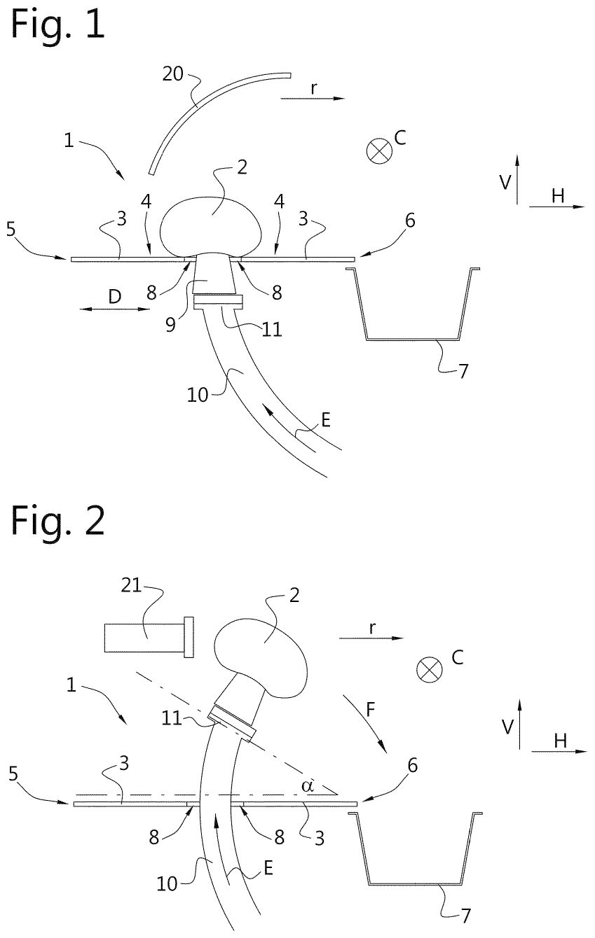

FIG. 1 shows a schematic cross section of a device according to the invention;

FIG. 2 shows the cross section from FIG. 1 in a different state;

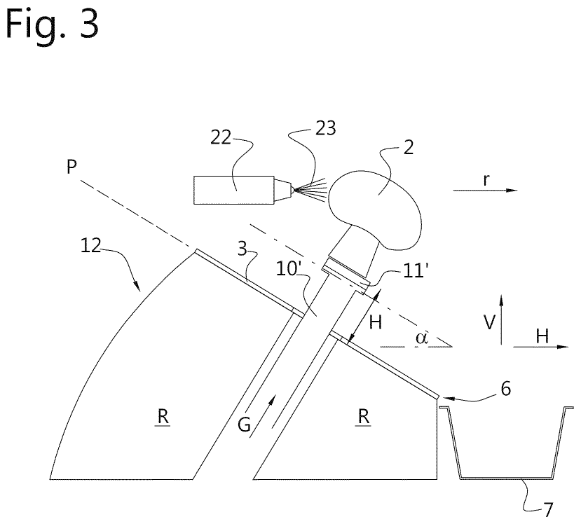

FIG. 3 shows a cross section of an alternative embodiment of a device according to the invention;

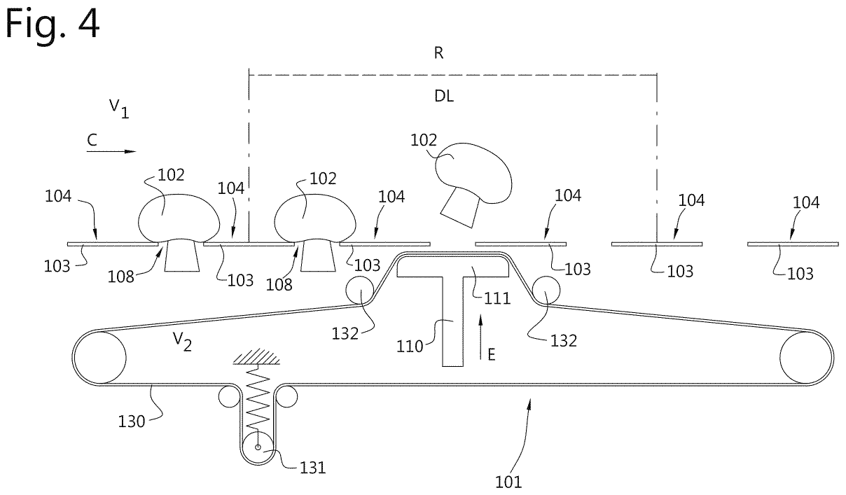

FIG. 4 shows a schematic cross section of yet another alternative embodiment of the present invention;

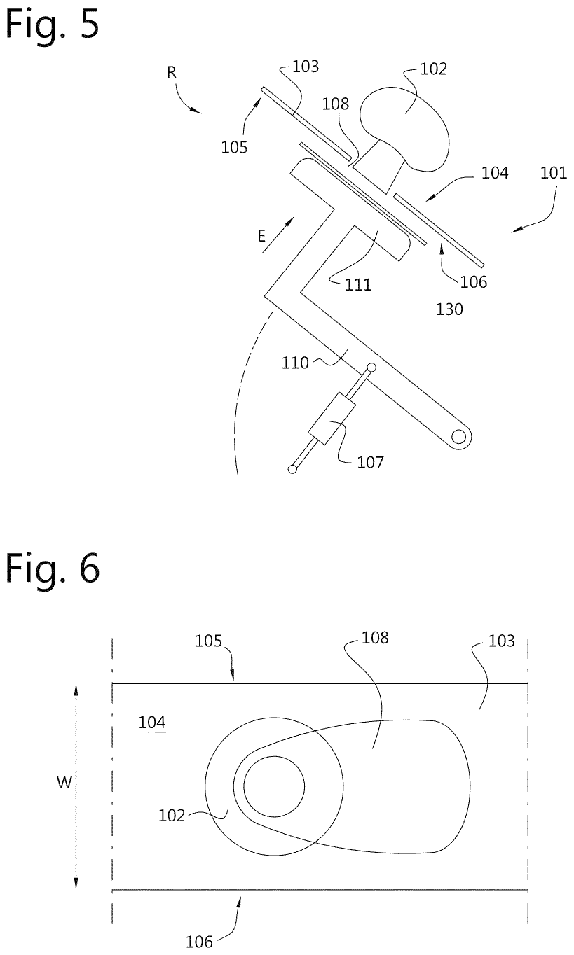

FIG. 5 shows a schematic cross section of the embodiment according to FIG. 4, in a direction of conveyance of the harvesting belt 103;

FIG. 6 shows a top view of a detail of the embodiment of FIGS. 4 and 5;

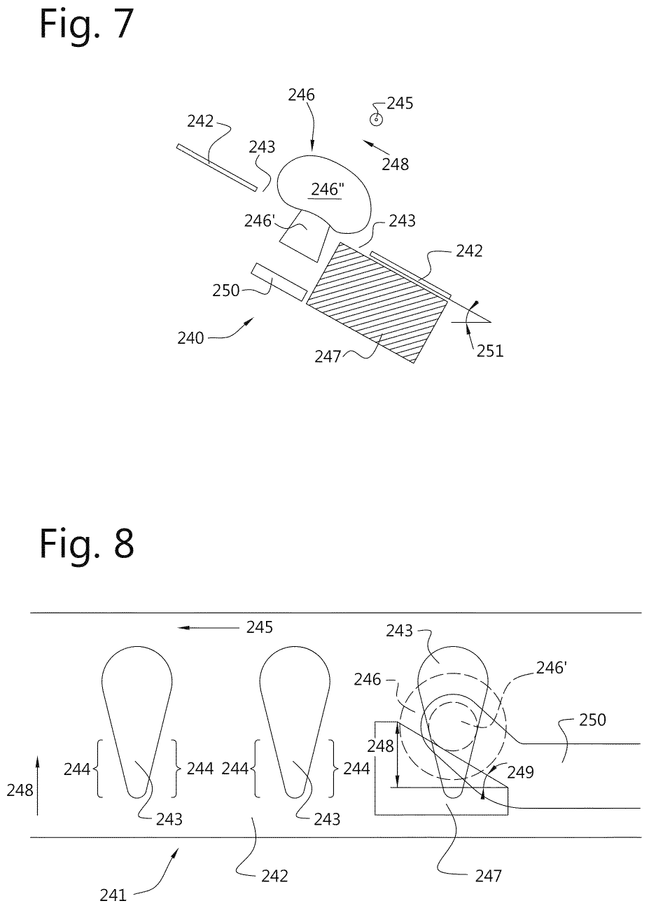

FIG. 7 shows a cross section of yet another embodiment of the present invention; and

FIG. 8 shows a top view of the embodiment of FIG. 7.

FIG. 1 shows a schematic cross section of a device 1 according to the invention, for discharging mushrooms 2 from a conveyor 3, formed by a conveyor belt for conveying the mushrooms in a direction of conveyance c, wherein the mushroom conveyor 3 has a surface 4 for carrying the mushrooms, which surface extends between two sides 5, 6 that are mutually spaced in a direction D perpendicular to the direction of conveyance C. The mushroom conveyor 3 is guided along a trajectory from a charging location such as a picking location to a discharging location (shown), which is a filling station for mushroom containers 7. The mushroom conveyor 3 has holes 8 for mushroom stipes 9, more in particular holes at a regular distance from each other in the direction of conveyance C. The device comprises a pusher 10, arranged underneath the conveyor at the discharging location, for pushing at least the mushroom stipes out of the holes by moving in a direction E with a pushing surface 11. FIG. 1 also shows an optional mushroom-guidance 20 which is embodied as a curved static plate, intended for physical contact with the mushroom 2, and to guide it to the intended direction which is in this case the right (r) direction.

FIG. 2 shows the cross section from FIG. 1 in a different state, wherein the pusher 10 has moved in the direction E and lifted the mushroom 2 from the conveyor 3. The movement in the direction E follows a curved path with a horizontal H and vertical V directional component. As a result, the mushroom 2 ends up in a tilted orientation with an angle alpha with respect to horizontal, from which it will fall in a direction F in the container 7. The pusher 10 extends through the hole 8 in the conveyor 3. This may in general be applied in embodiments according to the present invention. The pusher 10 in such embodiments may be configured to act at such speed that it pushes a mushroom 2 within the time a hole 8 in the conveyor belt 2 passes by the pusher. In that case, the conveyor belt 3 can be operated at continuous speed. Alternatively the conveyor belt 3 is started and stopped alternatingly and/or repeatedly. FIG. 2 shows an optional mushroom-guidance configured for physical contact, which is embodied as a dynamic second pusher 21 for moving the mushroom to the intended direction which is in this case the right (r) direction.

FIG. 3 shows a cross section of an alternative embodiment of a device 12 according to the invention. Again the pusher 10′ is movable, for pushing, with a vertical V directional component and a horizontal H directional component, in order to push a mushroom 2 to a side 6 of the conveyor 3, seen in the direction of conveyance C.

In this embodiment, the pusher 10′ and its pushing surface 11′ are configured to move along an essentially straight line G, which is perpendicular to the surface of the conveyor belt 3.

This surface is under an angle alpha with respect to the horizontal, comprising a twister, formed by a ramp R located at the discharging location, for at least locally twisting a plane P in which the surface of the mushroom conveyor 3 lies, wherein the twister is configured to twist the mushroom conveyor 3 about an axis parallel to direction of conveyance C. The embodiment also shows an optional mushroom-guidance, in this case configured not to make physical contact with the mushroom, but embodied as a nozzle 22 for creating an air stream 23 that moves the mushroom 2 in the intended direction, which is in the case shown the right (R) direction.

FIG. 4 shows a schematic cross section of a device 100 according to the invention, for discharging mushrooms 102 from a conveyor 103, formed by a conveyor belt for conveying the mushrooms in a direction of conveyance C, wherein the mushroom conveyor 103 has a surface 104 for carrying the mushrooms, which surface extends between two sides 105, 106 that are mutually spaced in a direction D perpendicular to the direction of conveyance C. The mushroom conveyor 103 is guided along a trajectory from a charging location such as a picking location to a discharging location (shown), which is a filling station for mushroom containers (not shown). The mushroom conveyor 103 has holes 108 for mushroom stipes 109, more in particular holes at a regular distance from each other in the direction of conveyance C. The device comprises a pusher 110, arranged underneath the conveyor and also under the second belt 30 at the discharging location, for pushing at least the mushroom stipes out of the holes 108 by moving in a direction E with a pushing surface 111. The pusher 110 pushed against the second belt 130 in this embodiment.

The second belt is guided along pusher 110 between two guides 132, and along its trajectory there is a tensioner 131 that allows to compensate for the belt length that the pushing requires.

FIG. 5 provides a side view of the same.

FIG. 6 shows a top view of the harvesting or mushroom conveyor belt with a width W, showing that the holes 108 for the mushroom stipes may be partially tapered in a length direction perpendicular to the width direction W. Mushroom stipes may be clamped in the opening and for that reason, the pusher belt may be set at a somewhat higher speed than the mushroom conveyor belt, in order to assist in removing the mushrooms from the holes.

FIG. 7 shows a cross sectional 240 view and FIG. 8 a top view 241 of another embodiment, wherein a belt 242 is provided with openings 243 that have a shape that is at least partially tapered 244 perpendicular to the direction of conveyance 45. In order to discharge the mushrooms 246 from the conveyor, a slider 247 may be present, forming means to slide the mushrooms 246 in the direction 248 wherein tapered part of the opening widens, which is, in this case, in the width direction of the belt 242. When the mushrooms 246 are slided in said direction 248 they are no longer held in a touching manner in the opening 243, and can be removed without being stuck in the opening 243 or being scratched by the edge of the opening 243.

In the embodiment shown, the slider 247 is a static device formed as a guidance bar, that (or at least an effective part thereof) extends both in a direction of conveyance 243 of the conveyor belt and in a direction 248 in which the tapered part of the openings of the belt widens, or, in other words, under an angle 249 with respect to said direction of conveyance 243. The slider 247 is positioned under the belt 242, that is, at the side wherein the stipes 246′ stick through the openings 243, or in other words the site remote from the side that supports the mushroom caps 246″. It is positioned such that it engages stipes 246′ of mushrooms 246 when transported by the belt 242.

The device also comprises a pusher 250. Also in this embodiment, the belt is twisted at the location where mushrooms are to be discharged and thus under an angle 251 with the horizontal. That may be done by means of a ramp of the aforementioned type. In that case, the twisting of the conveyor belt and/or the ramp are oriented such that the slider slides the mushrooms in the direction wherein the height of the ramp increases. This is also be the direction in which the tapered part 244 of the opening 242 widens.

Alternatively and/or additionally, at least part of the slider may be movable, and operated in dependence of a choice whether or not to discharge a certain mushroom passing a discharge location, and/or depending on mushroom properties. Especially a stipe size may be of influence of the action to be taken to remove the mushroom from the harvesting conveyor belt. Mushrooms with a smaller stipe tend to be positioned further into the tapered part of the hole in the conveyor belt, and may need a movement or a relative larger movement of the slider in the direction out of the conveyor belt.

The slider may be used in combination with a harvesting belt with round holes or a harvesting belt with holes with at least one tapered side. Its movement may be coupled, synchronised, triggered or related to the movement of the harvesting conveyor belt. More in particular is may be a combined movement, wherein one component of the movement is aimed at moving the mushroom stipe out of the tapered part of the opening in the conveyor belt, which movement may have a direction that is essentially in the plane of the belt, and another movement that is aimed at discharging the mushroom from the conveyor belt. Such movement may have a directional component perpendicular to the plane of the conveyor belt, and optionally also a directional component to a side of the conveyor belt. The belt may or may not be inclined with respect to a horizontal plane.

1. A device for discharging mushrooms from a conveyor, comprising:
A mushroom conveyor, in particular a conveyor belt and/or an endless conveyor, for conveying the mushrooms in a direction of conveyance;
wherein:
The mushroom conveyor has a surface for carrying the mushrooms, which surface extends between two sides that are mutually spaced in a direction perpendicular to the direction of conveyance; and
The mushroom conveyor being guided along a trajectory from a charging location to a discharging location, wherein the mushroom conveyor has holes for mushroom stipes, more in particular holes at a regular distance from each other in the direction of conveyance; and
a pusher, arranged underneath the conveyor at the discharging location, for pushing at least the mushroom stipes out of the holes with a pushing surface.

2. The device according to claim 1, wherein the pushing surface comprises or forms part of a rod or a plate, configured for direct physical contact with a mushroom, in particular with its stipe or configured for contact with a pushing conveyor, of which a pushing surface is arranged in between the mushroom conveyor and the pushing surface.

3. The device according to claim 1, wherein the pusher is configured for selectively pushing individual mushrooms, thus being enabled to selectively push some mushrooms and to leave other mushrooms on the mushroom conveyor.

4. The device according to claim 1, wherein the pusher is movable, for pushing, with a vertical directional component and a horizontal directional component, in order to push the mushroom to a side of the conveyor, seen in the direction of conveyance.

5. The device according to claim 1, wherein the pushing surface is configured for pushing along a curved path with a directional component toward a side of the conveyor belt.

6. The device according to claim 1, comprising a twister, located at the discharging location, for at least locally twisting a plane in which the surface of the mushroom conveyor lies, wherein the twister is configured to twist the mushroom conveyor about an axis parallel to direction of conveyance.

7. The device according to claim 1, wherein the holes in the mushroom convey or are tapered essentially in the direction of conveyance or essentially perpendicular thereto.

8. The device according to claim 7, comprising a slider, configured for moving the mushroom stipes in a direction in which the tapered part of the holes widens, in order to release the mushroom stipes from the conveyor belt.

9. The device according to claim 8, wherein the slider is stationary or movable with respect to the mushroom conveyor and/or the discharging location.

10. The device according to claim 1, wherein the twister comprises a ramp for guiding the mushroom conveyor, wherein the ramp extends over a full width of the mushroom conveyor, and in particular wherein the angle wherein the ramp twists the conveyor is adjustable, and/or wherein the ramp is exchangeable, wherein the ramp has a recess or a different height at the area where it supports the part of the mushroom conveyor that comprises the holes.

11. A combination of the device according to claim 1 and a filling station for mushroom containers, wherein the filling station comprises:
means for providing mushroom containers, wherein the means convey the containers to the discharging location, for catching mushrooms discharged from the mushroom conveyor.

12. The combination according to claim 11, comprising multiple means, and in particular multiple container conveyors, at a mutual distance in the transport direction, leading to different filling stations at various positions at the mushroom conveyor, wherein the pushers are controllable, such that mushrooms can be selectively removed from the mushroom conveyor at one filling station, while already having passed another filling station upstream.

13. The combination according to claim 12, wherein the selective removal is based on mushroom properties, which is measured or otherwise determined at an upstream location.

14. The combination according to claim 11, wherein
the means for providing mushroom containers convey the containers to a location below the twister, for catching mushrooms discharged from the mushroom conveyor.

15. The combination according to claim 11, wherein the means extend from a destacker location where containers are destacked onto the means, in particular to a buffer location, where containers are stored for buffering.

16. The device according to claim 1 wherein the charging location comprises a picking location.

17. The device according to claim 1 wherein the discharging location comprises a filling station for mushroom containers.

18. The combination according to claim 11 wherein the mushroom containers comprise trays.

19. The combination according to claim 11 wherein the means for providing mushroom containers comprise at least one container conveyor.

20. The combination according to claim 13 wherein the mushroom properties comprise size and/or weight.
